(19) United States
(12) Patent Application Publication
(10) Pub. No.: US 2020/0169555 A1
(43) Pub. Date: May 28, 2020

(54) DEVICE AND METHOD FOR COMMUNICATION BETWEEN IN-VEHICLE DEVICES OVER INTRA-VEHICLE NETWORK BASED ON AUTOMOTIVE ETHERNET

(71) Applicant: ELECTRONICS AND TELECOMMUNICATIONS RESEARCH INSTITUTE, Daejeon (KR)

(72) Inventors: Bo Heung CHUNG, Daejeon (KR); Dae Won KIM, Daejeon (KR); Jin Yong LEE, Daejeon (KR); Boo Sun JEON, Daejeon (KR); Hong Il JU, Daejeon (KR); Byeong Cheol CHOI, Daejeon (KR)

(21) Appl. No.: 16/682,237

(22) Filed: Nov. 13, 2019

(30) Foreign Application Priority Data
Nov. 26, 2018 (KR) 10-2018-0147440

(51) Int. Cl. H04L 29/06; H04L 12/40

(52) U.S. Cl. CPC H04L 63/0876; H04L 12/40; H04L 2012/40273; H04L 2012/40215; H04L 63/029

(57) ABSTRACT

A transmission method of a domain gateway over a vehicle network based on automotive Ethernet includes receiving, by a domain gateway of a first domain, transmission data on a CAN packet basis from a transmitting-side ECU; transmitting, by the domain gateway of the first domain, the transmission on an Ethernet packet basis to a domain gateway of a second domain; and transmitting, by the domain gateway of the second domain, the transmission data on a CAN packet basis to a receiving-side ECU. The CAN packet includes a CAN ID field, and the CAN ID field includes a CAN message section and an authentication section.

### CROSS REFERENCE TO RELATED APPLICATION

The present application claims priority to Korean Patent Application No. 10-2018-0147440, filed Nov. 26, 2018, the entire content of which is incorporated herein for all purposes by this reference.

### BACKGROUND OF THE INVENTION

### 1. Field of the Invention

The present invention relates to a device and method for communication between in-vehicle devices over an intra-vehicle network based on automotive Ethernet. More particularly, the present invention relates to a method for ensuring security in in-vehicle communication over an intra-vehicle network in which an existing legacy system (for example, a control area network (CAN)) and an automotive Ethernet system are both used.

### 2. Description of the Related Art

In recent years, with advancement of convergence of technologies such as Internet of things (IoT), high-speed communication, and artificial intelligence, automobiles have evolved from simple transportation to multifunctional transportation providing social and cultural benefits to people. In order to deal with this, comprehensive analysis on data from a variety of sensors and image information is required. To meet this demand, the need for automotive Ethernet is rapidly increasing, and there have already been attempts to apply Ethernet technology to intra-vehicle networks. The control area network (CAN) which is a classic legacy protocol uses an 8-byte packet and allows for a maximum bus speed of 1 Mbps, and the CAN-FD which is an extension to the original CAN uses a 64-byte packet size. With these legacy protocols, it is difficult to satisfy the high-bandwidth requirements of these sensors. In addition, encryption and authentication are not easy to be employed in legacy protocols such as CAN due to their characteristics such as broadcast transmission and a short packet size. Therefore, most approaches consider a method of modifying the CAN so as to implement a new protocol enabling authentication and encryption or a method of adding a hardware security module (HSM) to an electronic control unit (ECU).

However, these approaches require the use of a high-end ECU capable of performing authentication and encryption or addition of a high-computing-power HSM to an existing ECU. Specifically, when transmission data is encrypted, an encrypted message needs to be divided into multiple CAN packets for transmission and reception, and a receiving-side ECU needs to be equipped with a hardware unit that can collect all of the transmitted CAN packets for decryption of the encrypted message. Therefore, a new approach is required which enables identification and authentication of ECUs in a communication process without using a high-end ECU allowing for complex data processing such as encryption or without adding an additional hardware piece to an existing ECU.

### SUMMARY OF THE INVENTION

There present invention has been made in view of the problems occurring in the related art, and an objective of the present invention is to provide a device and method for communication between in-vehicle devices over an intra-vehicle network based on automotive Ethernet.

Another objective of the present invention is to provide a method of ensuring security in in-vehicle communication in an intra-vehicle network in which an existing legacy system such as CAN and an automotive Ethernet system are both used.

A further objective of the present invention is to provide a method of ensuring data safety by performing identification and authentication of a transmitting-side device during communication in a heterogeneous network environment.

A further objective of the present invention is to provide a method of ensuring data security during transmission and reception of the data in a heterogeneous network without using an additional protocol or device.

A further objective of the present invention is to provide a communication environment that ensures connectivity of in-vehicle devices while minimally modifying a legacy protocol used in an existing device in a heterogeneous network in which a legacy system and a new automotive Ethernet system are both used.

According to one embodiment of the present invention, there is provided a communication method of a domain gateway over a vehicle network based on automotive Ethernet. The communication method may include: receiving, by a domain gateway of a first domain, transmission data on a CAN packet basis from a transmitting-side ECU; transmitting, by the domain gateway of the first domain, the transmission on an Ethernet packet basis to a domain gateway of a second domain; and transmitting, by the domain gateway of the second domain, the transmission data on a CAN packet basis to a receiving-side ECU. The CAN packet may include a CAN ID field, and the CAN ID field may include a CAN message section and an authentication section.

According to one embodiment of the present invention, there is provided a vehicle network for automotive Ethernet-based communication. The vehicle network may include a plurality of domain gateways and a plurality of ECUs. When a transmitting-side ECU of the plurality of ECUs transmits data to a receiving-side ECU of the plurality of ECUs, a domain gateway of a first domain of the plurality of domain gateways receives the data on a CAN packet basis from the transmitting-side ECU, the domain gateway of the first domain transmits the data on an Ethernet packet basis to a gate of a second domain, and the domain gateway of the second domain transmits the data on a CAN packet basis to the receiving-side ECU. In this case, a CAN packet includes a CAN ID field, and the CAN ID field includes a CAN message section and an authentication section.

According to one embodiment of the present invention, there is provided a domain gateway that performs communication over a vehicle network based on automotive Ethernet. The domain gateway may include a memory unit configured to store data, a transceiver configured to transmit and receive data, and a processor configured to control the memory device and the transceiver. The processor of the domain gateway may receive transmission data on a CAN packet basis from a transmitting-side ECU and transmits the transmission data on an Ethernet packet basis to a domain gateway of an external domain, in which the transmission data is transmitted to a receiving-side ECU on a CAN packet basis via the domain gateway of the external domain, the CAN packet includes a CAN ID field, and the CAN ID field includes a CAN message section and an authentical section.

Details described below may apply to both of a vehicle network and a vehicle network-based operation method.

According to one embodiment of the present invention, the CAN message section may consist of at least of one bit to represent identification information of a CAN message.

According to one embodiment of the present invention, when the transmission data is converted from a CAN packet to an Ethernet packet, authentication may be performed.

According to one embodiment of the present invention, the authentication may be performed on the basis of the authentication section which is included in the CAN ID field.

According to one embodiment of the present invention, as the number of bits constituting the authentication section is increased, a security level is raised.

According to one embodiment of the present invention, when an ECU is registered with a domain gateway, the number of bits constituting the CAN message section and the number of bits constituting the authentication section may be determined.

According to one embodiment of the present invention, the ECU may transmit information on the CAN message section to the domain gateway, the domain gateway may transmit authentication information to the ECU, and the number of bits constituting the CAN message section and the number of bits constituting the authentication section may be determined on the basis of information exchanged between the domain gateway and the ECU.

According to one embodiment of the present invention, the domain gateways may perform automotive Ethernet-based communication with each other, the ECUs may perform CAN-based communication with each other, and the domain gateway and the ECU may perform CAN-based communication with each other.

According to one embodiment of the present invention, an Ethernet packet transmitted from a domain gateway of a first domain to a domain gateway of a second domain may include a CAN ID field including a CAN message section and an authentication section.

According to one embodiment of the present invention, when an Ethernet packet transmitted from a domain gateway of a first domain to a domain gateway of a second domain includes a CAN ID field including a CAN message section, authentication information may be included in the Ethernet packet separately from the CAN ID field.

According to the present invention, it is possible to provide a communication method for in-vehicle devices over an intra-vehicle network based on automotive Ethernet.

According to the present invention, it is possible to provide a method of ensuring security in in-vehicle communication over an intra-vehicle network in which a legacy system (for example, control area network (CAN)) and an automotive Ethernet system are both used.

According to the present invention, it is possible to provide a method of ensuring data safety by enabling identification and authentication of a transmitting-side device for communication between devices in a heterogeneous network environment.

According to the present invention, it is possible to provide a method of ensuring data security during transmission and reception of data in a heterogeneous network without using an additional protocol or device.

According to the present invention, it is possible to provide a communication environment that ensures connectivity of in-vehicle devices while minimally modifying a legacy protocol used in an existing device in a heterogeneous network in which a legacy system and a new automotive Ethernet system are both used.

The effects and advantages that can be achieved by the present disclosure are not limited to the ones mentioned above, and other effects and advantages which are not mentioned above but can be achieved by the present disclosure can be clearly understood by those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating an intra-vehicle network based on an automotive Ethernet according to one embodiment of the present invention;

FIG. 2 is a diagram illustrating a data transmission method in an intra-vehicle heterogenous network according to one embodiment of the present invention;

FIG. 3 is a diagram illustrating a secure data transmission method in an intra-vehicle heterogenous network according to one embodiment of the present invention;

FIG. 4 is a diagram illustrating a method of performing secure data transmission, according to one embodiment of the present invention;

FIG. 5 is a diagram illustrating a method of generating a NEW CAN ID, according to one embodiment of the present invention;

FIG. 6 is a diagram illustrating a NEW CAN ID generation process;

FIG. 7 is a flowchart illustrating a method of generating a NEW CAN ID, according to one embodiment of the present invention;

FIG. 8 is diagrams illustrating (a) the format of a CAN packet including an original CAN ID and (b) the format of a CAN packet including a NEW CAN ID (i.e., modified CAN ID), respectively, according to one embodiment of the present invention;

FIG. 9 is a diagram illustrating a heterogeneous network environment in which a NEW CAN ID is used, according to one embodiment of the present invention;

FIG. 10 is a diagram illustrating a communication method for in-vehicle devices, according to one embodiment of the present invention; and

FIG. 11 is a diagram illustrating a configuration of an ECU or a domain gateway, according to one embodiment of the present invention.

### DETAILED DESCRIPTION OF THE DISCLOSURE

Hereinbelow, exemplary embodiments of the present invention will be described in detail with reference to the accompanying drawings such that the invention can be easily practiced by those ordinarily skilled in the art to which this disclosure belongs. However, the present disclosure may be embodied in various forms and should not be construed as being limited to the exemplary embodiments disclosed herein.

In describing embodiments of the present disclosure, well-known functions or constructions will not be described in detail when it is determined that they may obscure the spirit of the present disclosure. Further, components not related to the present disclosure are not shown in the drawings and like reference numerals are given to like components.

It is to be understood in the following description that when one component is referred to as being “connected to”, “combined with”, or “coupled to” another component, it may include not only direct connection, but indirect connection with another component therebetween. It will be further understood that when a component “comprises” or “has” another component, it means that the component may further include another component, not excluding another component unless stated otherwise.

It will be understood that, although the terms “first”, “second”, etc. may be used herein to describe various components, these components should not be limited by these terms. These terms are only used to distinguish one component from another component. For instance, a first component discussed below could be termed a second component without departing from the teachings of the present invention. Similarly, the second component could also be termed the first component.

In the following description, components are discriminated from each other to clearly describe their characteristics, but it does not mean that they are necessarily physically separated. That is, a plurality of components may be integrated in one hardware or software module and one component may be divided into a plurality of hardware or software modules. Accordingly, integrated or divided embodiments are included in the scope of the present disclosure even if not specifically stated.

In the following description, components described with reference to various embodiments are not all necessarily required and some components may be selectively used. Accordingly, embodiments composed of some of the components described in one embodiment are also included in the scope of the present disclosure. Further, embodiments implemented by adding components to various embodiments are also included in the scope of the present disclosure.

The advantages and features of the present invention and the manner of achieving them will become apparent with reference to the embodiments described in detail below and the accompanying drawings. The present invention may, however, be embodied in many different forms and should not be construed as being limited to the embodiments set forth herein. Rather, these embodiments are provided so that the present invention will be thorough and complete and will fully convey the concept of the invention to those skilled in the art.

In the present disclosure, an environment in which a legacy network such as a controller area network (CAN) and an automotive Ethernet are both used is considered. In this case, there is a need for identification and authentication of a transmitting-side device (for example, ECU) when data transmission is performed between the automotive Ethernet and the CAN. For example, it is necessary to analyze and group individual devices connected to the networks into several groups (i.e., domains). In this case, identification of data and authentication of devices are performed on a group basis (i.e., domain basis). For example, when identification and authentication information used in a first group (domain) is transferred to a second group (domain), the identification and authentication information used in the first group (domain) is converted into a format that can be recognized by devices belonging to the second group (domain) before the information is transmitted. This process will be described below.

In this case, when grouping-based management is performed as described above, individual devices can be managed with the least management cost in a heterogeneous network environment including an automotive Ethernet network and a legacy network, and a safe and reliable network environment can be provided.

Hereinbelow, a communication method for in-vehicle devices for providing a secure and reliable networking service for devices connected to an automotive Ethernet-based intra-vehicle network will be described.

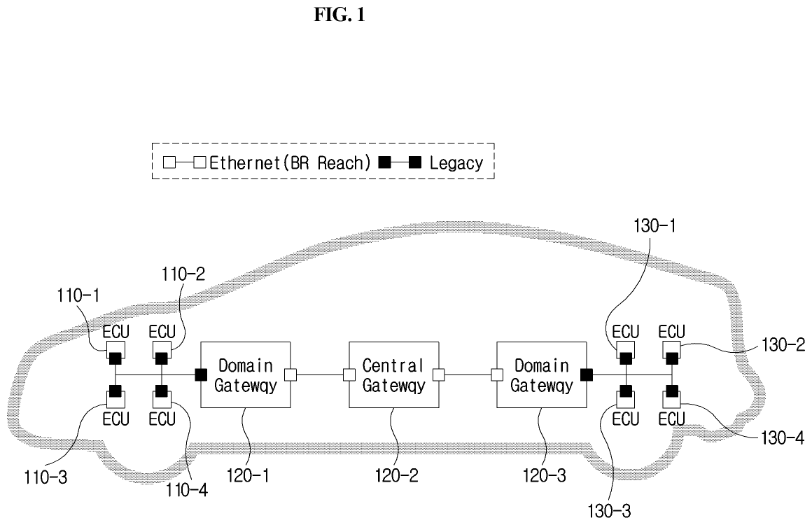

FIG. 1 is a diagram illustrating an intra-vehicle network based on automotive Ethernet. Ethernet is one of the network models and specifically refers to a wired network technology. Ethernet enables communication with high-level security and high data transmission efficiency. For example, recently developed intelligent vehicles can provide a variety of services such as smart traffic analysis, autonomous driving, unattended driving, etc. To this end, compared to existing vehicles, advanced vehicles are required to have the ability to perform comprehensive analysis on image information and various sensing information for detection of surrounding vehicles and measurement of distances to obstacles. Therefore, automotive Ethernet that can offer a broad bandwidth is increasingly required. Considering this, introduction of automotive Ethernet to vehicles is required. For example, a vehicle network is configured to process a large amount of data that increases over time due to the use of a variety of sensors and a connected car service based on automotive Ethernet. For example, services using a high-resolution video, such as driver assistance systems, may require high-volume data processing. Automotive Ethernet finds its application in vehicles to support such systems.

In terms of a system, a vehicle includes at least one of an ECU, a sensor, and an actuator. For communication between ECUs, an intra-vehicle network is required. In the past, communication between ECUs was performed over a control area network (CAN) which is one of the legacy networks. Instead of the CAN, a different legacy network can be used. That is, the legacy network is not limited to the CAN. Hereinafter, a CAN as a legacy network will be described for convenience of description but the legacy network is not limited to the CAN. That is, the present invention applies to communication between a legacy network and an automotive Ethernet-based network, and the present invention is not limited thereto.

Referring to FIG. 1, in an intra-vehicle network based on automotive Ethernet, in-vehicle devices (for example, ECUs) 110-1, 110-2, 110-3, 110-4, 130-1, 130-2, 130-3, and 130-4 are connected by a bus-based network which is one of the legacy networks to form a logical domain. The in-vehicle devices in a domain can be connected to devices in an external domain via domain gateways 120-1, 120-2, and 120-3. For connection to an external domain, an in-vehicle device within one domain may be directly connected to a domain gateway of the external domain through automotive Ethernet or may be indirectly connected via a central gateway 120-2.

Specifically, referring to FIG. 1, the ECUs 110-1, 110-2, 110-3, and 110-4 within a first domain are connected by a control area network (CAN). That is, the ECUs 110-1, 110-2, 110-3, and 110-4 within the first domain communicate with each other using a legacy network. In this case, the domain gateway 120-1 of the first domain is connected with the ECUs 110-1, 110-2, 110-3, and 110-4 included in the first domain and can communicate with an external domain gateway, for example, the central gateway 120-2. In this case, the domain gateway 120-1 can communicate with the ECUs 110-1, 110-2, 110-3, and 110-4 using a CAN protocol. However, the domain gateway 120-1 and the central gateway 120-2 communicate with each other using an automotive Ethernet-based network. The domain gateway 120-3 of a third domain communicates with the ECUs 130-1, 130-2, 130-3, and 130-4 within the third domain by using the CAN protocol, but communicates with the central gateway 120-2 by using an automotive Ethernet-based network. That is, a vehicle network is composed of legacy networks and automotive Ethernet networks, and the legacy network and the automotive Ethernet network can be connected to each other. Hereinbelow, a heterogeneous network including an automotive Ethernet network is simply referred to as a heterogeneous network. That is, the term “heterogeneous network” refers to a vehicle network that operates in conditions described above.

For example, when an ECU of a certain domain (hereinafter, referred to as a first domain for convenience of description) transmits data to another domain (hereinafter, referred to as a second domain for convenience of description), data is first transmitted to the domain gateway of the first domain on a CAN packet basis from the ECU of the first domain, the CAN packets are then converted into Ethernet packets by the domain gateway of the first domain, the Ethernet packets are then transmitted to the domain gateway of the second domain from the domain gateway of the first domain. Next, the domain gateway of the second domain converts the Ethernet packets back into CAN packets and transmits the data (i.e., the CAN packets) to a final destination ECU of the second domain.

For example, referring to FIG. 1, when a first ECU 110-1 transmits data to a second ECU 130-1, the first ECU 110-1 transmits the data in the form of CAN packets to the domain gateway 120-1, first. The domain gateway 120-1 converts the CAN packets into Ethernet packets and transmits the Ethernet packets to the domain gateway 120-3 via the central gateway 120-2. The domain gateway 120-3 which has received the Ethernet packets converts the Ethernet packets into CAN packets and transmits the CAN packets to the second ECU 130-1.

In the process described above, in order to ensure communication security between a transmitting-side ECU and a receiving-side ECU, it is necessary to identify the transmitting-side ECU and verify the data received by the receiving-side ECU.

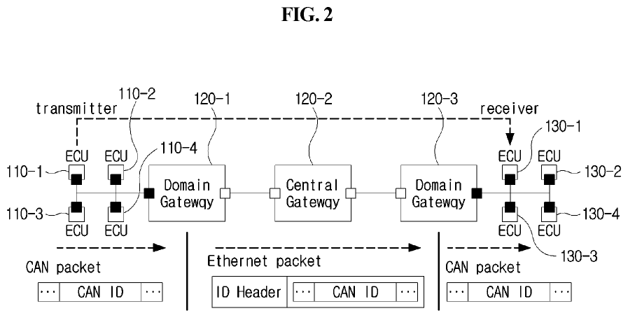

Specifically, FIG. 2 is a diagram illustrating a data transmission method in an intra-vehicle heterogenous network. Referring to FIG. 2, data can be transmitted from the transmitting-side ECU 110-1 to the receiving-side ECU 130-1 over an intra-vehicle heterogeneous network. In this case, as described above, CAN packets are first converted into Ethernet packets and then converted back into CAN packets. The CAN packets received by the domain gateway 120-1 of the first domain from the transmitting-side ECU 110-1 are converted into the Ethernet packets by the domain gateway 120-1 of the first domain and are then transmitted to the domain gateway 120-3 of the second domain. For example, referring to FIG. 2, the Ethernet packets are delivered from the domain gateway 120-1 of the first domain to the domain gateway 120-3 of the second domain via the central gateway 120-2. However, the delivery route of the packets is not limited thereto. That is, when data is transmitted between domain gateways, the data is transmitted in the form of Ethernet packets. Next, the domain gateway 120-3 of the second domain converts the Ethernet packets into CAN packets and transmits the CAN packets to the receiving-side ECU 130-1. For secure communication through the whole communication process, it is required to verify whether a packet at each stage is the data transmitted from a secure and normal ECU. For example, a CAN packet has a limited size of 8 bytes and is transmitted in a broadcasting manner. Therefore, a CAN packet can be encrypted for secure transmission. However, when a complicated encryption and decryption algorithm is used to raise a security level, the transmission cost increases. Since a CAN packet has a limited size, transmission data needs to be divided into a plurality of CAN packets for transmission. Accordingly, there is inconvenience that the receiving side needs to collect and integrate all of the CAN packets for decryption of the data, resulting in deterioration in transmission efficiency. In order to mitigate this inconvenience, an idea of adding a hardware security module (HSM) to an ECU is considered so that the ECU can perform the whole process described above at high speed. However, it is difficult to put this idea into practical use.

In view of all the circumstances, a new communication method that can overcome the use of CAN packets in an intra-vehicle heterogeneous network is required.

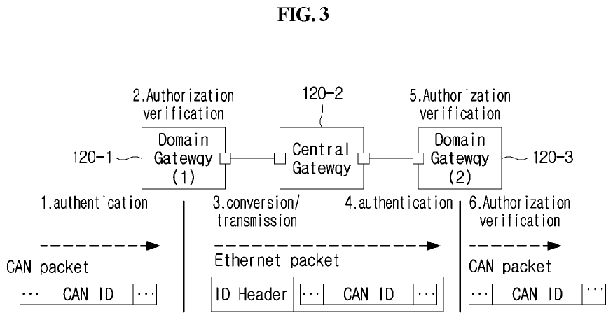

As a possible solution, FIG. 3 illustrates a secure data transmission method in an intra-vehicle heterogenous network according to one embodiment of the present invention.

Referring to FIG. 3, information contained in a CAN packet received by a domain gateway 120-1 of a first domain is used to authenticate a transmitting-side ECU. That is, the transmitting-side ECU is authenticated first. Next, when the domain gateway 120-1 of the first domain transmits the received data to a domain gateway of an external domain (referred to as a second domain), the domain gateway 120-1 of the first domain checks the received data for authorization, then converts the CAN packet into an Ethernet packet, and then transmits the Ethernet packet to the domain gateway 120-3 of the second domain. The Ethernet packet can be transmitted to the domain gateway 120-3 of the second domain via a central gateway 120-2, but the transmission of the Ethernet packet is not necessarily performed as such. Next, the domain gateway 120-3 of the second domain performs authentication and authorization checking with respect to the Ethernet packet. Next, the domain gateway 120-3 of the second domain converts the Ethernet packet into a CAN packet and transmits the CAN packet to a final destination (i.e., a receiving-side ECU). In this case, authentication information for authenticating the transmitting-side ECU is included in the CAN packet received by the domain gateway 120-1 of the first domain. The authentication information is also included in the packet that is transmitted to the domain gateway 120-3 of the second domain from the domain gateway 120-1 of the first domain. When a legacy network is used for authentication of an automotive Ethernet network in a heterogeneous network environment, transmission of the information needs to be performed while avoiding a significant modification to an existing protocol to maintain backward compatibility with the legacy network.

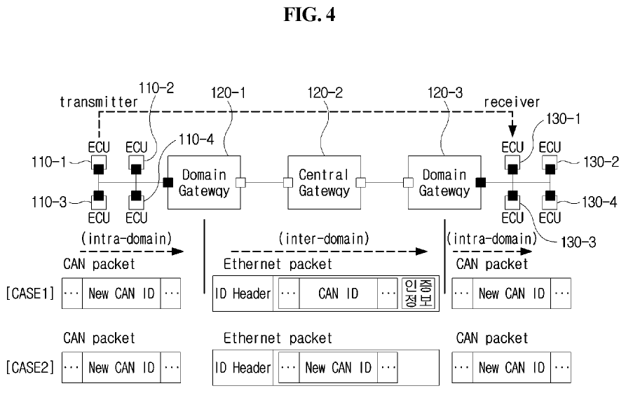

FIG. 4 is a diagram illustrating an exemplary method for secure data transmission.

With the use of the method illustrated in FIG. 4, it is possible to perform secure data transmission through authentication and authorization checking while minimally modifying an existing protocol. An automotive Ethernet network environment requires a domain gateway compared to a legacy network. In this case, the domain gateway plays a key role in secure transmission. The domain gateway can perform authentication while minimizing a change to an existing CAN protocol.

Specifically, a transmitting-side ECU 110-1 performs transmission using a “NEW CAN ID” for authentication of the ECU. That is, the transmitting-side ECU 110 sets a NEW CAN ID for use in authentication of the transmitting-side ECU and inserts the NEW CAN ID into a CAN packet to be transmitted to a domain gateway 120-1 of a first domain. The value of the CAN ID varies depending on automobile manufacturers. The CAN ID included in the CAN packet takes up 11 bits. Since the CAN packet is data transmitted between an ECU and a domain gateway within the same domain, the CAN packet can be transmitted using a NEW CAN ID having a different form from an original CAN ID. For example, herein, the original CAN ID is conveniently referred to as “global CAN ID”. A CAN ID that is used only within the domain needs not be a “global CAN ID”. A “local CAN ID” which consists of a smaller number of bits than the global CAN ID can be used for transmission within a domain. That is, the number of bits used for the local CAN ID is less than 11 bits and the remaining bits of the 11 bits can be used for authentication. In this way, the “NEW CAN ID” is generated for local transmission within the domain. The “NEW CAN ID” includes identification information for use within the domain and authentication information. Thus, it is possible to allocate several bits for authentication without changing the overall structure of a CAN packet or a CAN protocol. That is, while the NEW CAN ID is used when data is locally transmitted within a domain, the predefined CAN ID (original CAN ID) is used when data is globally transmitted.

For example, as in Case 1 of FIG. 4, “NEW CAN ID” is used as a new CAN ID for data transmission within a domain. However, in an Ethernet packet, the original CAN ID is used instead of the new CAN ID, and authentication information is additionally included. Next, a domain gateway of a second domain can derive the “NEW CAN ID” from the authentication information and the original CAN ID included in the Ethernet packet and can transmit the derived “NEW CAN ID” to a receiving-side ECU. Thus, authentication can be performed on the basis of the original CAN ID.

As another example, as in Case 2 of FIG. 4, a “NEW CAN ID” that is defined for use in a CAN packet can also be applied to an Ethernet packet. That is, the “NEW CAN ID” can be included within the payload of an Ethernet packet. Therefore, the domain gateway of the second domain can transmit the “NEW CAN ID” to the receiving-side ECU by using the payload of the Ethernet packet.

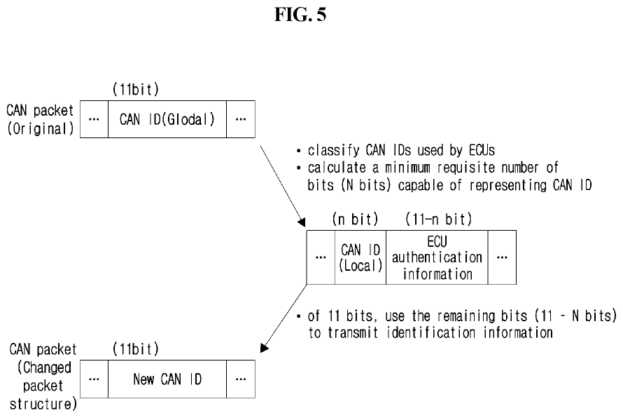

Specifically, FIG. 5 illustrates a method of generating the NEW CAN ID. Referring to FIG. 5, a CAN packet is formatted to include various information. Fields (for example, ACK, CRC, etc.) other than a CAN ID field are closely associated with a CAN protocol. Thus, when the number of bits for each of those fields is changed, a designated operation according to the CAN protocol cannot be performed. Therefore, it is necessary to maintain the number of bits for each of the fields such as ACK, CRC, etc. that are closely associated with the CAN protocol. For this reason, authentication is performed by changing only a CAN ID field within the structure of a CAN packet. Types of CAN messages used by the ECUs within a domain can be identified. The types of the CAN messages may correspond to the distribution of the values of the CAN IDs. Therefore, it is possible to determine the number of bits required to represent the CAN ID on the basis of the distribution of the values of the CAN IDs used by the ECUs.

For example, when a domain includes six ECUs and 15 types of messages are used by the ECUs, only four bits are required to represent the CAN IDs. The number of bits required for the CAN IDs is determined depending on the number of ECUs or the number of types of CAN messages used in a domain. In the example described above, since 15 types of messages are used, four bits are required to identify the types of the messages. In another example, a domain includes multiple ECUs that use the same type of messages. In this case, the number of bits for representing the CAN IDs for use within the domain is determined on the basis of the number of ECUs. However, the method of determining the number of bits for representing the CAN IDs for use within a domain is not limited thereto. That is, the number of bits for representing the CAN IDs for use within a domain is determined on the basis of the number of ECUs or the number of types of CAN messages. However, the determination method is not limited thereto. In this case, the CAN ID field is defined with 11 bits. However, since only four bits of the 11 bits are required to represent the CAN IDs when data is transmitted within the domain, the remaining 7 bits of the 11 bits can be used for different purposes. For example, the remaining 7 bits can be used for authentication of an ECU. That is, the minimum number of bits for representing the CAN ID used for transmission of a CAN message within a domain is first calculated to check how many bits of the 11 bits can be used for authentication.

The data packaged in a CAN packet that is transmitted using a NEW CAN ID is transmitted to a domain gateway and is then post-processed (for example, authenticated) by the domain gateway. After the post processing, the data is transmitted to an external domain as necessary. When the data is transmitted between the domains, a global CAN ID is used. Therefore, the data can be easily transmitted between domains using original CAN IDs.

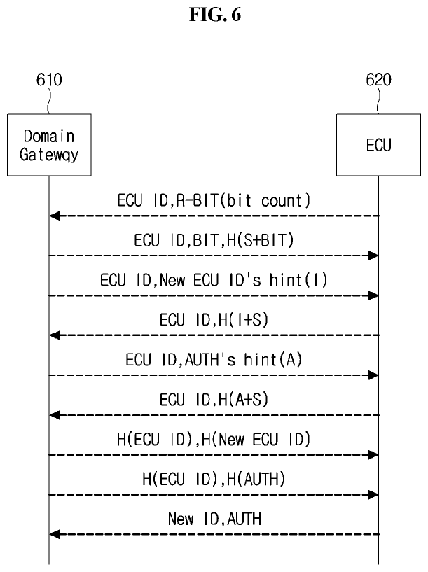

FIG. 6 is a diagram illustrating a NEW CAN ID generation process. Referring to FIG. 6, when an ECU 620 is registered with a domain gateway 610, the domain gateway 610 generates a NEW CAN ID for the ECU 620 to be registered. At this time, the ECU may inform the domain gateway of the number of bits required to represent its ID. The domain gateway may transmit authentication information to the ECU. To this end, the domain gateway and the ECU share a hash function and shared information S with each other. For example, the domain gateway and the ECU may share a function that can generate an actual new ECU ID and authentication information from the new ECU ID and hint information about the authentication information AUTH transmitted from the domain gateway.

Specifically, the domain gateway 610 receives an ECU ID and CAN ID bit count information R-BIT from the ECU 620. In this case, the domain gateway 610 transmits the ECU ID, the CAN ID bit count information BIT, and an H (S+BIT) value to the ECU. Here, the S is a shared value or key. The H (S+BIT) value is a hash value that is the sum of the shared value S and the bit count value BIT. That is, the domain gateway 610 generates a hash value using its own shared value S and the bit count value BIT and transmits information on the hash value to the ECU 620. The ECU 620 calculates a hash value using the received bit count value BIT and its own shared value S, and compares the calculated hash value with the hash value received from the domain gateway 610.

Next, the domain gateway 610 can provide an ECU ID and a hint I about a new ECU ID to the ECU 620. In this case, the ECU 620 calculates the sum (I+S) of its own shared value S and a hint value I about the ECU ID and obtains a hash value H (I+S). The ECU 620 transmits the ECU ID and the hash value H (I+S) to the domain gateway 610. Since the domain gateway 610 is already aware of both of the shared value and the hint value I about the new ECU ID, the domain gateway 610 can calculate the sum (I+S) of the hint value I and the shared value S, obtains a hash value H (I+S), and compare the calculated hash value with the hash value received from the ECU 620.

Next, when the domain gateway 610 confirms that the value described above is normally transmitted, an authentication information hint value A is processed. That is, the domain gateway 610 transmits the ECU ID and the authentication information hint value A to the ECU 620. In this case, the ECU 620 calculates the sum (A+S) of the authentication information hint value A about the ECU ID and the shared value S and then obtains a hash value H (A+S). The ECU 620 transmits the ECU ID and the hash value H (A+S) to the domain gateway 610. Since the domain gateway 610 is aware of both of the shared value S and the authentication information hint value A regarding the new ECU ID, the domain gateway 610 can calculate the sum (A+S) of the hint value A and the shared value S, obtains a hash value H (A+S), and compares the calculated hash value with the hash value received from the ECU 620.

Next, the domain gateway 610 delivers H (ECU ID) and H (New ECU ID) to the ECU 620. Next, the domain gateway 610 delivers the H (ECU ID) and the H(AUTH) to the ECU 620. At this time, the ECU 620 can calculate the NEW ECU ID and the AUTH value using its own hint value. In addition, hash values can be calculated. At this time, the ECU 620 compares its own hash value with the received hash value. When the own hash value and the received hash value match, the new ECU ID and the AUTH value are transmitted to the domain gateway 610. That is, the transmission process is finished. Thereafter, data can be transmitted to the domain gateway using the NEW CAN ID in which authentication information is included. Since CAN packets can be transmitted in a broadcasting manner, the domain gateway 610 and the ECU 620 can continuously transmit packets in each of which the authentication information is included.

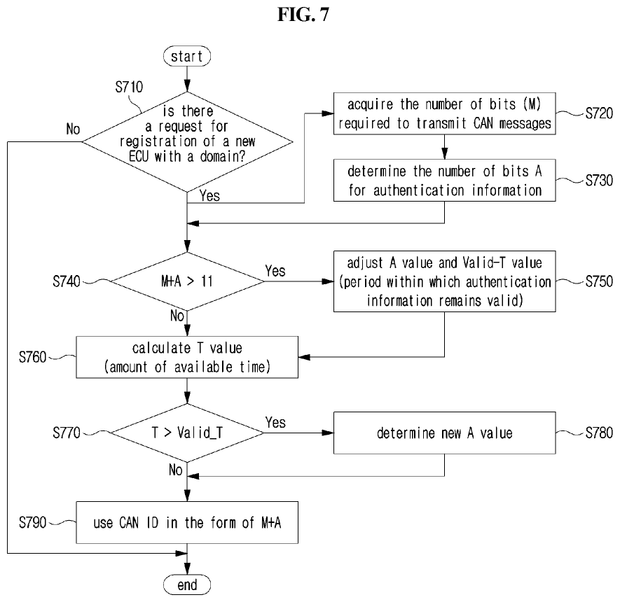

Specifically, FIG. 7 is a flowchart illustrating a NEW CAN ID generation method.

For example, referring to FIG. 7, an ECU makes a request for registration with a domain gateway (S710). At this time, when the ECU makes a registration request, the number of bits M required for transmission of a CAN message can be obtained (S720). In addition, the number of bits A required for authentication information can be determined (S730). At this time, it is possible to determine whether the sum of the number of bits M for a CAN message and the number of bits A for authentication information is greater than 11 (S740). As described in a previous example, since the number of bits of the CAN ID field of a CAN packet is 11, when the sum of the number of bits M for a CAN message and the number of bits A for authentication information exceeds 11 bits, the necessary information cannot be entirely inserted into the CAN packet. Therefore, whether the total bit count (M+A) of the number of bits M for a CAN message and the number of bits A for authentication information is greater than 11 is checked first. When the total bit count (M+A) is greater than 11, the number of bits A for authentication information is adjusted. The smaller the number of bits A for authentication information, the lower the security level. As the number of bits A for authentication information is increased, the security level is raised. In view of this, the number of bits A and an authentication information effective time Valid_T can be adjusted. That is, the effective time (duration) for which the authentication information is valid is adjusted to be reduced (S750), and then the value of an available time T is calculated (S760). When the available time T is longer than the effective time Valid_T, a new A value is used (S770). When the effective time for the case where the A bit value is 8 is equal to the effective time for the case where the A bit value is 4, a security strength is lowered. On the contrary, when the available time T is shorter than the effective time Valid_T, the CAN ID is formed in the form of M+A (S790). That is, when the ECU is registered in the manner described above, a new CAN ID can be generated.

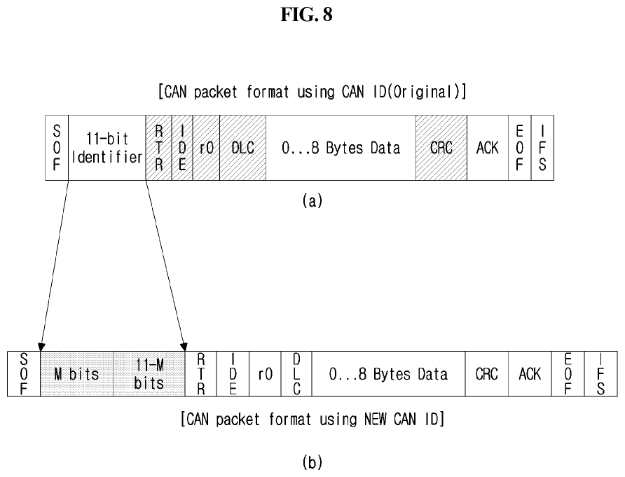

FIG. 8(a) is a diagram illustrating the format of a CAN packet based on the original CAN ID and FIG. 8(b) is a diagram illustrating the format of a CAN packet based on the NEW CAN ID.

Comparing the CAN packet of FIG. 8(a) and the CAN packet of FIG. 8(b), the fields other than the CAN ID field are identical to each other. That is, since there is no change to the CAN protocol, secure communication can be performed over the network. For example, the total length of the CAN packet is not changed although the NEW CAN ID is used. In addition, of the fields of the CAN packet, the fields (e.g., CRC and ACK) associated with an operation have the same format as the fields of the original CAN packet in view of backward compatibility with legacy systems.

Comparing the CAN packet of FIG. 8(a) and the CAN packet of FIG. 8(b), an 11-bit identifier field (CAN ID) is divided into M bits and 11−M bits, in which the M bits are used for transmission of a newly defined CAN message. The 11−M bits are used for transmission of authentication information on a transmitter, which will be described in more detail below.

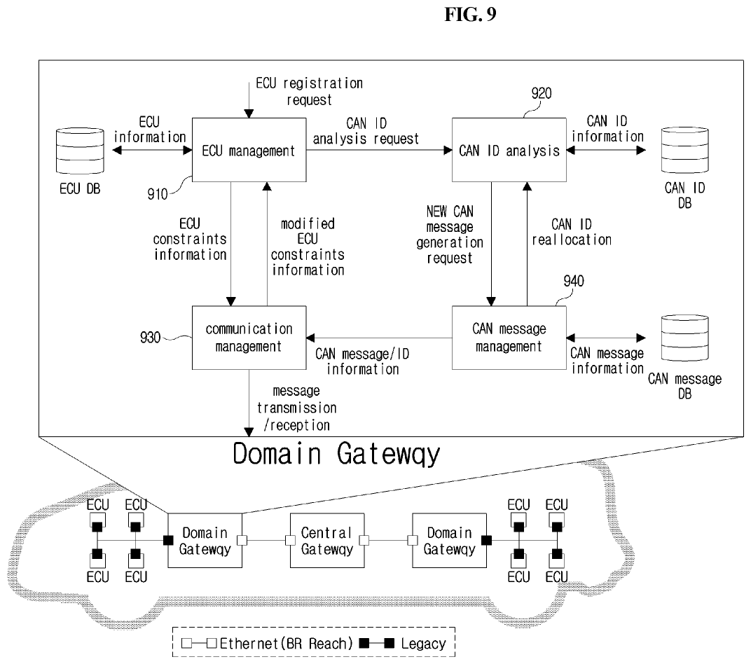

For example, FIG. 9 is a diagram illustrating a heterogeneous network environment in which a NEW CAN ID described above is used.

Referring to FIG. 9, a domain gateway can be divided into an ECU management unit 910, a CAN ID analysis unit 920, a CAN message management unit 930, and a communication management unit 940. The ECU management unit 910 manages information on ECUs belonging to the domain. When a new ECU registration request is received, the ECU management unit 810 mediates among a CAN ID analysis function, a CAN ID reallocation function, and a communication management function. This operation is the same as that of FIG. 7. The CAN ID analysis unit 920 analyzes the ranges of CAN IDs that have been requested and the range of a NEW CAN ID that is requested currently by the ECU management unit. When the CAN ID analysis unit 920 delivers the analysis results to the CAN message management unit 940, a NEW CAN ID is reallocated. In this case, the CAN message management unit 940 stores the NEW CAN ID in a CAN ID database after the CAN ID analysis is performed, or sends the NEW CAN ID to the communication management unit so that the NEW CAN ID can be verified in the subsequent communication process. The communication management unit 930 checks whether transmission and reception of data packets are normally performed using the NEW CAN ID over the network. A system used for this process is the same as one that is described above.

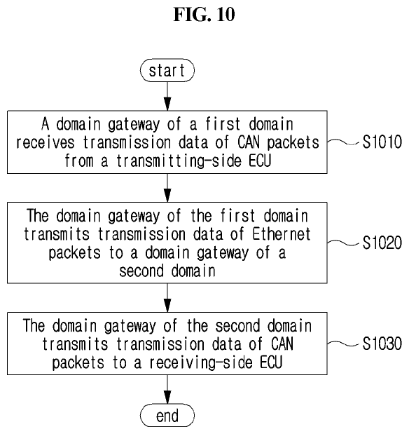

FIG. 10 is a diagram illustrating a communication method for in-vehicle devices, according to one embodiment of the present invention.

Referring to FIG. 10, a domain gateway of a first domain transmits transmission data on the basis of CAN packets received from a transmitting-side ECU (S1010). As described above with reference to FIGS. 1 to 9, domain gateways and ECUs are devices connected to an intra-vehicle network. The intra-vehicle network may be a heterogeneous network in which different protocols are used.

For example, it is assumed there is data to be transmitted to a receiving-side ECU from the transmitting-side ECU. When the transmitting-side ECU and the receiving-side ECU can be connected to each other by a control area network (CAN), the transmitting-side ECU can directly transmit data to the receiving-side ECU on a CAN packet basis. On the other hand, a case where the transmitting-side ECU transmits data to the receiving-side ECU via a domain gateway may be considered. In this case, a domain gateway of a first domain receives transmission data on a CAN packet basis from the transmitting-side ECU. Next, the domain gateway of the first domain performs data conversion from the CAN packets into Ethernet packets and transmits the transmission data on an Ethernet packet basis to a domain gateway of a second domain. Next, the domain gateway of the second domain changes the Ethernet packet back into the CAN packet and transmits the CAN packet to the receiving-side ECU (S1030). That is, data can be transmitted through data packet conversion in a heterogenous network environment. When the packets of the transmission data are transmitted through the data packet conversion, authentication is necessarily performed. That is, data transmission from the transmitting-side ECU is performed through the identification of the transmitting-side ECU and the subsequent authentication of the transmitting-side ECU. In this case, authentication information can be inserted into a CAN packet while maintaining the format of the CAN packet, and the CAN packet is then transmitted. As described above, the CAN packet includes a CAN ID field. The CAN ID field consists of 11 bits. When data is transmitted within a domain, it is not necessary to use all the 11 bits to represent a CAN ID. That is, of the 11 bits, some bits are not used to represent the CAN ID. Therefore, of the 11 bits allocated for the CAN ID field, only several bits are used to differentiate CAN messages from each other and the remaining bits can be used for transmission of authentication information.

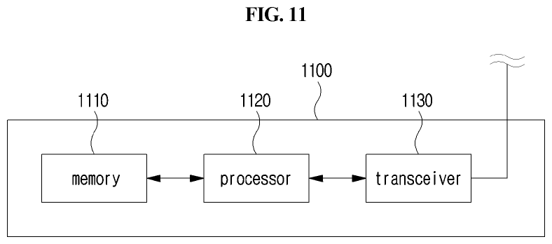

FIG. 11 is a diagram illustrating a configuration of an ECU or a domain gateway, according to one embodiment of the present invention.

The ECU or domain gateway is a device within a vehicle network. That is, each of the devices can operate as a stand-alone device and is configured as illustrated in FIG. 11.

That is, referring to FIG. 11, each of the devices 1100 may include at least one of a memory unit 1110, a processor 1120, and a transceiver 1130. The memory unit 1110 functions to store information in a vehicle, authentication information, identification information, and other associated information. The processor 1120 controls the information stored in the memory unit 1110 according to the method described above. The processor 1120 transmits a signal to another device via the transceiver 1130. For example, the signal can be transmitted on a CAN packet basis or an Ethernet packet basis, and the signal transmission is not limited thereto.

That is, each of the devices that operate over a vehicle network system has the configuration described above. Thus, the devices can perform transmission and reception of data over a vehicle network.

In order to implement the method according to the present disclosure, each of the embodiments described above can be modified such that some additional steps can be added to a corresponding embodiment or some existing steps can be eliminated from a corresponding embodiment. Alternatively, some additional steps are added and some existing steps are eliminated from a corresponding of the embodiments.

Various embodiments in the present disclosure are not intended to represent all of the possible combinations based on technical spirit of the present invention but are provided only for illustrative purposes. Elements or steps described in various embodiments can be applied independently or in combination.

Various embodiments in the present disclosure can be implemented by hardware, firmware, software, or a combination thereof. When implemented by hardware, each of the embodiments can be implemented by one or more application specific integrated circuits (ASICs), digital signal processors (DSPs), digital signal processing devices (DSPDs), programmable logic devices (PLDs), field programmable gate arrays (FPGAs), general processors, controllers, micro controllers, or micro-processors.

The scope of the present disclosure covers software or machine-executable commands (for example, operating systems (OSs), application programs, firmware, programs) that enable steps in various embodiments to be performed in a certain device or computer, and a non-transitory computer-readable medium in which such software or commands are stored so as to be executable in a certain device or computer when read.

What is claimed is:

1. A communication method for a domain gateway over a vehicle network based on automotive Ethernet, the communication method comprising:
receiving, by a domain gateway of a first domain, transmission data on a CAN packet basis from a transmitting-side ECU;
transmitting, by the domain gateway of the first domain, the transmission data on an Ethernet packet basis to a domain gateway of a second domain; and
transmitting, by the domain gateway of the second domain, the transmission data on a CAN packet basis to a receiving-side ECU,
wherein the CAN packet includes a CAN ID field, and the CAN ID field includes a CAN message section and an authentication section.

2. The communication method according to claim 1, wherein the CAN message section is used to represent identification information with which the domain gateways can identify a CAN message.

3. The communication method according to claim 1, wherein when the transmission data is converted from the CAN packet to the Ethernet packet, authentication is performed.

4. The communication method according to claim 3, wherein the authentication is performed using the authentication section of the CAN ID field.

5. The communication method according to claim 4, wherein as the number of bits for authentication is increased, a security level is raised.

6. The communication method according to claim 1, wherein when the transmitting-side ECU or the receiving-side ECU is registered with a corresponding one of the domain gateways, the number of bits of the CAN message section and the number of bits of the authentication section within the CAN ID field for the corresponding ECU are determined.

7. The communication method according to claim 6, wherein the transmitting-side ECU transmits information on the number of bits of the CAN message section to the domain gateway of the first domain, the domain gateway of the first domain transmits the authentication information to the transmitting-side ECU, and the number of bits for a CAN message and the number of bits for authentication are determined on the basis of information exchanged between the domain gateway and the ECU.

8. The communication method according to claim 1, wherein the domain gateways perform automotive Ethernet-based communication with each other,
the ECUs perform CAN-based communication with each other, and
the domain gateways and the ECU perform CAN-based communication with each other.

9. The communication method according to claim 1, wherein the Ethernet packet transmitted from the domain gateway of the first domain to the domain gateway of the second domain includes a CAN ID field including a CAN message section and an authentication section.

10. The communication method according to claim 1, wherein when the Ethernet packet transmitted from the domain gateway of the first domain to the domain gateway of the second domain includes a CAN ID field including a CAN message section, the Ethernet packet includes authentication information that is separately included from the CAN ID field.

11. A vehicle network performing communication based on automotive Ethernet, the vehicle network comprising:
a plurality of domain gateways; and
a plurality of ECUs,
wherein when a transmitting-side ECU of the plurality of ECUs transmits data to a receiving-side ECU of the plurality of ECUs, a domain gateway of a first domain of the plurality of domain gateways receives the data on a CAN packet basis from the transmitting-side ECU,
the domain gateway of the first domain transmits the data on an Ethernet packet basis to a domain gateway of a second domain of the plurality of domain gateways,
the domain gateway of the second domain transmits the data on a CAN packet basis to the receiving-side ECU,
the CAN packet includes a CAN ID field, and
the CAN ID field includes a CAN message section and an authentication section.

12. The vehicle network according to claim 11, wherein the CAN message section represents information used to identify a CAN message by the domain gateway.

13. The vehicle network according to claim 11, wherein when the transmission data is converted from the CAN packet to the Ethernet packet, authentication is performed.

14. The vehicle network according to claim 13, wherein the authentication is performed on the basis of the authentication section of the CAN ID field.

15. The vehicle network according to claim 14, wherein as the number of bits constituting the authentication section increases, a security level is raised.

16. The vehicle network according to claim 11, wherein when one of the ECUs is registered with one of the domain gateways, the number of bits constituting the CAN message section and the number of bits constituting the authentication section are determined.

17. The vehicle network according to claim 11, wherein the domain gateways perform automotive Ethernet-based communication with each other,
the ECUs perform CAN-based communication with each other, and
each of the domain gateways and each of the ECUs perform CAN-based communication with each other.

18. The vehicle network according to claim 11, wherein the Ethernet packet transmitted from the domain gateway of the first domain to the domain gateway of the second domain includes a CAN ID field including a CAN message section and an authentication section.

19. The vehicle network according to claim 11, wherein when the Ethernet packet transmitted from the domain gateway of the first domain to the domain gateway of the second domain includes a CAN ID field including a CAN message section, the Ethernet packet includes authentication information that is separately included from the CAN ID field.

20. A domain gateway that performs communication over a vehicle network based on automotive Ethernet, the domain gateway comprising:
a memory unit configured to store data;
a transceiver configured to transmit and receive data; and
a processor configured to control the memory unit and the transceiver,
wherein the processor receives transmission data on a CAN packet basis from a transmitting-side ECU, and transmits the transmission data on an Ethernet packet basis to an external domain gateway,
the transmission data is transmitted to a receiving-side ECU on a CAN packet basis via the external domain gateway,
the CAN packet includes a CAN ID field, and
the CAN ID field includes a CAN message section and an authentication section.
